(19) United States
(12) Patent Application Publication
(10) Pub. No.: US 2016/0129813 A1
(43) Pub. Date: May 12, 2016

(54) Armrest Extension

(71) Applicant: Terry Darling, Greenup, IL (US)

(72) Inventor: Terry Darling, Greenup, IL (US)

(21) Appl. No.: 14/928,924

(22) Filed: Oct. 30, 2015

Related U.S. Application Data
(60) Provisional application No. 62/078,474, filed on Nov. 12, 2014.

(51) Int. Cl. B60N 2/46

(52) U.S. Cl. CPC B60N 2/4673

(57) ABSTRACT

An armrest extension for the door of a consumer or commercial vehicle, including a passenger car, SUV, pickup truck, or commercial truck. The extension provides comfort to drivers by raising the height of a factory armrest to be about level with the steering wheel. The extension attaches to the top of the factory armrest, elevates the factory armrest, and extends outward from the factory armrest. The extension is manufactured from a soft, sturdy material for stability and to prevent damage to the factory armrest.

### CROSS-REFERENCE TO RELATED APPLICATIONS

This Application claims the benefit of U.S. Provisional Application No. 62/078,474, filed Nov. 12, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle seat attachments and in particular to an armrest extension for a vehicle door. The standard equipment seats and armrests provided in passenger vehicles, SUVs, pickup trucks, and commercial trucks are not comfortable for all drivers, generally because the armrest is typically lower than the steering wheel. An armrest extension, which attaches to the standard vehicle armrest and extends upward and outward would resolve this problem.

Some existing armrest modifications already exist but are not optimally designed to work efficiently with the factory armrests provided in passenger vehicles, SUV's, pickup trucks, or commercial trucks. Many of these armrest modifications are designed to attach to the existing armrests using adhesive strips. This can damage the existing armrest and may not even work in many cases where the armrest has a fabric material on the outside surface. Some other modifications must be screwed into the door panel and use hook and loop fasteners and belts to attach to the factory armrest. Again, this can damage the existing armrest and door panel. Neither of these designs is easily and quickly installed or removed from the vehicle.

### SUMMARY OF THE INVENTION

Accordingly, the invention is directed to an armrest extension for the door of a consumer or commercial vehicle, including a passenger car, SUV, pickup truck, or commercial truck. The extension provides comfort to drivers by raising the height of a factory armrest to be about level with the steering wheel. The extension attaches to the top of the factory armrest, elevates the factory armrest, and extends outward from the factory armrest. The extension is manufactured from a soft, sturdy material for stability and to prevent damage to the factory armrest.

The present invention has a protrusion which extends downward from the main body of the extension. This protrusion is configured to fit snuggly within the bezel of the factory armrest. This configuration allows the extension to be quickly and easily installed on or removed from virtually any vehicle door. It does not use any means of attachment which may damage the factory armrest or door panel because it uses friction to hold itself in place in the bezel of the armrest.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a rear view of the first exemplary embodiment, displaying the extension 10, the top surface 11, the protrusion 12, the main body 13, and the outside edge 17.

FIG. 2 is a right side view of the first exemplary embodiment, displaying the extension 10, the top surface 11, the protrusion 12, the main body 13, and the outer surface 16.

FIG. 3 is a top view of the first exemplary embodiment, displaying the extension 10, the top surface 11, and the main body 13.

FIG. 4 is a left side perspective view of the first exemplary embodiment, displaying the extension 10, the top surface 11, the protrusion 12, and the main body 13.

FIG. 5 is a right side perspective view of a car door armrest, displaying the armrest 14 and the bezel 15.

FIG. 6 is a rear view of the first exemplary embodiment installed on a car door armrest such that the protrusion and bezel are shown as dashed lines as they are within the armrest, displaying the extension 10, the top surface 11, the protrusion 12, the main body 13, the armrest 14, and the bezel 15.

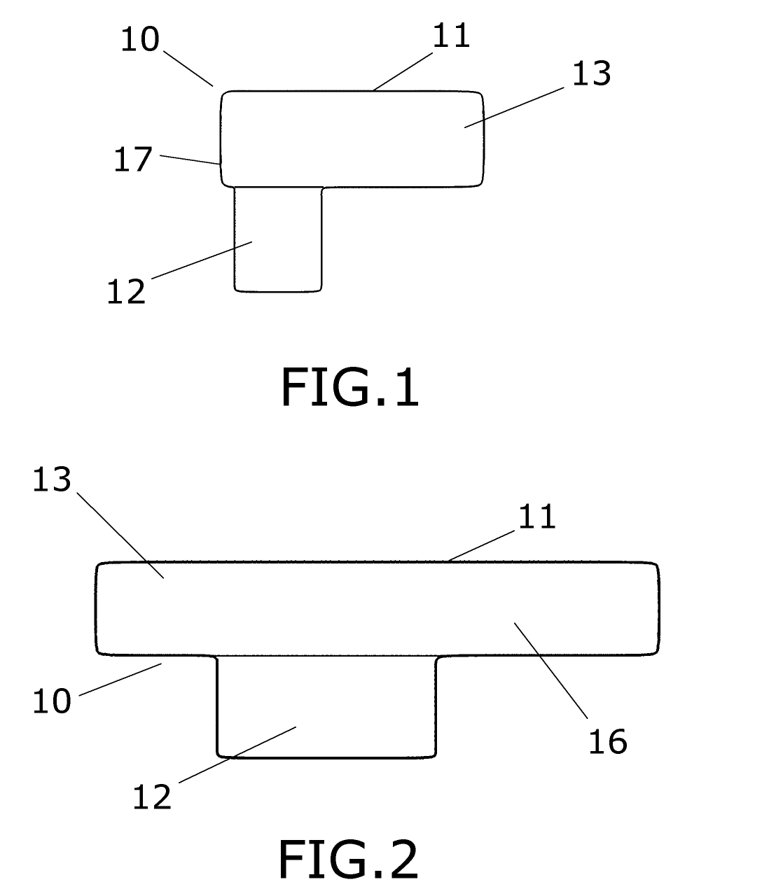

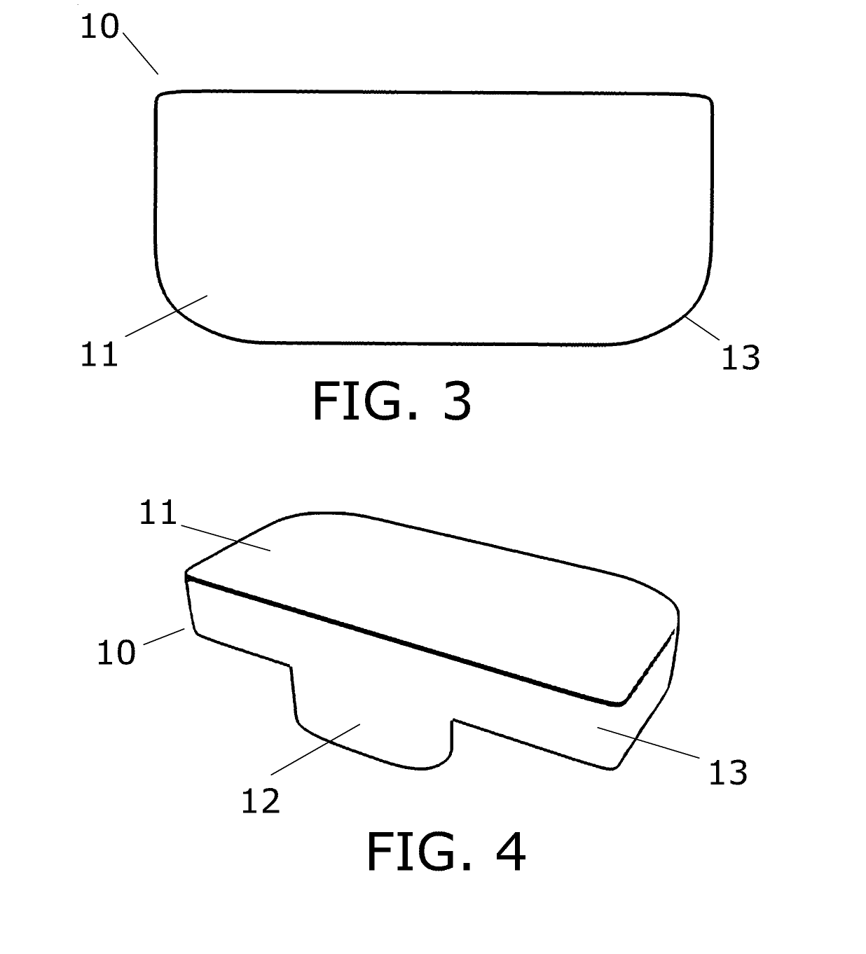

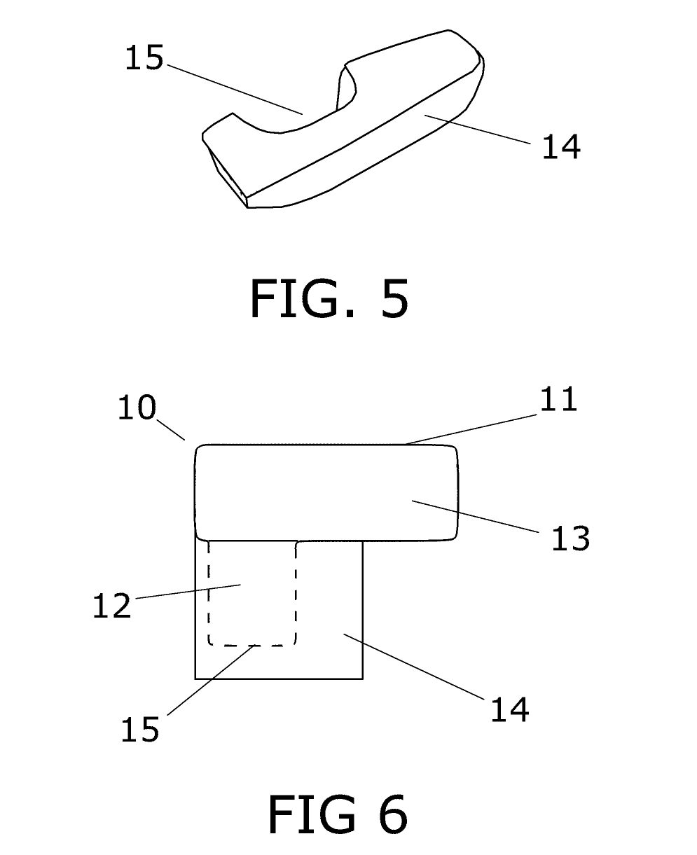

### DETAILED DESCRIPTION OF THE INVENTION

Referring now to the invention in more detail, the invention is directed to an armrest extension 10 for a vehicle door, including a standard side-opening vehicle door, a vertical opening vehicle door, or a slide opening vehicle door.

The first exemplary embodiment is comprised of an armrest extension 10 which provides comfort to drivers by raising the height of a factory armrest 14 to about the height of the lower edge of the steering wheel. The extension 10 attaches to the top of the factory armrest 14, providing a protrusion 12 on its bottom surface which fits snugly into the bezel 15 of the armrest 14, and is easily detached and lifted out. The protrusion 12, which is attached to the main body 13, is inserted into the bezel 15 of the armrest 14, securing the extension 10 in position on top of the armrest, through friction and flexibility.

The extension 10 is manufactured from a soft, sturdy material for stability and to prevent damage to the factory armrest. The top surface 11 preferably provides softer padding than the other surfaces of the extension 10. The extension 10 is also provided in a reversed version for the passenger side of the vehicle, and for drivers in certain countries such as the United Kingdom, where the driver sits on the right side of the vehicle.

The dimensions of the extension 10 are preferably 11 inches in length, 5 inches in width, and 2⅜ inches in depth. The protrusion 12 is preferably 4½ inches in length, 1½ inches in width, and 2 inches in depth. The protrusion 12 is preferably located 2¼ inches from the inside surface of the extension 10 and is flush with the outside edge 17.

To use the first exemplary embodiment, the user places the extension 10 on top of the factory armrest and presses downward on the top surface 11 such that the protrusion 12 inserts fully into the bezel.

The extension 10 is preferably manufactured with a rigid core which is preferably manufactured from a rigid, durable material such as wood or aluminum alloy, covered with a padding which is preferably manufactured from a flexible, durable material such as foam rubber, and further covered with an outer surface 16 which is preferably manufactured from a flexible, durable material which is waterproof and easily cleaned, such as plastic or vinyl.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An armrest extension for the armrest of the door of a vehicle, comprising:
a. a main body;
b. a protrusion;
c. said protrusion extending downward from said main body;
d. said protrusion being configured and sized to fit snugly into a bezel of a car door armrest such that said main body rests on top of said car door armrest; and
e. a top surface providing soft padding.

2. The armrest extension of claim 1, wherein said protrusion, when inserted into the bezel of the armrest, secures the armrest extension in position through friction and flexibility.

3. The armrest extension of claim 1, wherein said protrusion extends downward from said main body near an outside edge.

4. The armrest extension of claim 2, wherein said protrusion extends downward from said main body near an outside edge.

5. The armrest extension of claim 1, wherein said armrest extension has an outer surface which is flexible and easily cleaned.

6. The armrest extension of claim 2, wherein said armrest extension has an outer surface which is flexible and easily cleaned.

7. The armrest extension of claim 3, wherein said armrest extension has an outer surface which is flexible and easily cleaned.

8. The armrest extension of claim 4, wherein said armrest extension has an outer surface which is flexible and easily cleaned.
